(19) United States
(12) Patent Application Publication
(10) Pub. No.: US 2007/0176442 A1
(43) Pub. Date: Aug. 2, 2007

(54) Bumper stay

(75) Inventors: Tatsuro Mori, Farmington Hills, MI (US); Aaron Stando, Farmington Hills, MI (US)

Correspondence Address: YOUNG & BASILE, P.C., 3001 WEST BIG BEAVER ROAD, SUITE 624, TROY, MI, 48084, US

(73) Assignee: Nissan Technical Center North America, Inc., Farmington Hills, MI (US)

(21) Appl. No.: 11/342,496

(22) Filed: Jan. 30, 2006

(51) Int. Cl. B60R 19/34

(52) U.S. Cl. 293/133

(57) ABSTRACT

A bumper stay for a vehicle adapted to extend between the vehicle platform and the vehicle bumper. The bumper stay includes a first length and a second length with the first length being crushable relative to the second length. The relative lengths of the first and second sublengths are varied to provide a bumper stay of specified crushability useable with all members of a family of vehicles having a common platform.

### FIELD OF THE INVENTION

This invention relates to vehicle bumper systems and more particularly to a bumper stay for connecting the bumper beam to a vehicle.

### BACKGROUND

Vehicle bumper systems typically include a bumper beam, cladding covering the front face of the bumper beam, and a stay extending from the vehicle chassis or other component to the bumper beam. It is now common practice to provide a family of vehicles having a common chassis, frame or other structural components (sometimes referred to herein as a “platform”) but having varying overhang between the platform and the bumper beam. This requires that the bumper stay or stays for the various members of the vehicle family based on the common platform vary in length in proportion to the extent of overhang, the longest overhang requiring the longest stays. As stays get longer, their performance in impact situations becomes more difficult to predict. Specifically, during a high speed impact the stay should ideally collapse evenly about its axis. Longer stays, however, exhibit a greater tendency to buckle or break rather than collapse evenly about the stay axis.

### SUMMARY

In accordance with one aspect of the invention, a bumper stay for a vehicle is provided. The bumper stay extends between a component of the vehicle and a vehicle bumper. The stay includes a first length that is relatively crushable; and a second length that is relatively non-crushable.

In accordance with another aspect of the invention, a method is provided for installing a vehicle bumper stay for use in one of a plurality of vehicles that have common platforms, but different overhangs. The method includes providing a bumper stay adapted to extend between a vehicle component and a vehicle bumper, the bumper stay having a first length that is relatively crushable and is of a predetermined size, and a second length that is relatively non-crushable and is of a size selected to permit the bumper stay to span the distance between the vehicle component and the bumper; and then securing the bumper stay to the vehicle component and the bumper.

### BRIEF DESCRIPTION OF THE DRAWINGS

The description herein makes reference to the accompanying drawings wherein like reference numerals refer to like parts throughout the several views, and wherein:

FIG. 1 is a schematic perspective view of a bumper assembly including a first embodiment of the bumper stay disclosed herein;

FIG. 2 is a detail view of the bumper stay of FIG. 1;

FIG. 3 is a detail cross-sectional view of the bumper stay of FIG. 1;

FIG. 4 is a plan view of the bumper stay of FIG. 1;

FIG. 5 is a schematic perspective view of a bumper assembly including a second embodiment of the bumper stay disclosed herein;

FIG. 6 is a detail view of the bumper stay of FIG. 5;

FIGS. 7 and 8 are cross-sectional views taken respectively on lines 7-7 and 8-8 of FIG. 6;

FIG. 9 is a plan view of the bumper stay of FIG. 6;

FIGS. 10, 11 and 12 are schematic views illustrating a methodology as disclosed herein; and

FIGS. 10A, 11A and 12A illustrate, respectively, the bumper stays utilized in FIGS. 10, 11 and 12.

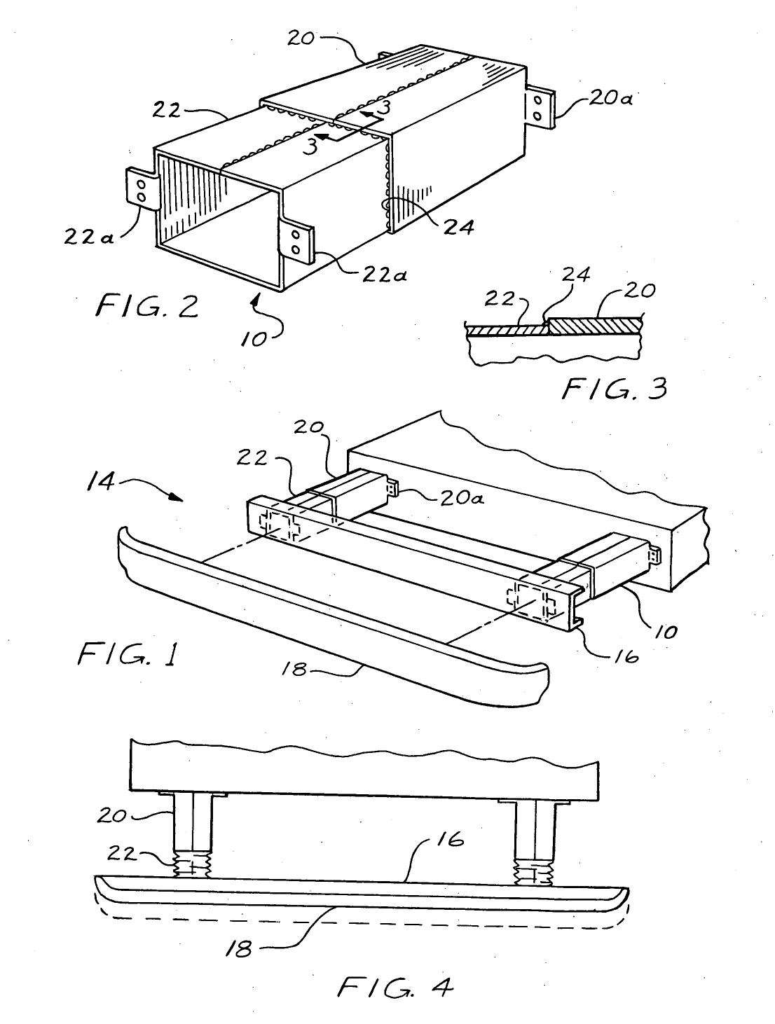

### DETAILED DESCRIPTION

As used herein, references to a component being secured, attached or otherwise connected to a vehicle platform include both direct connection (such as, for example, attachment to the chassis) as well as connection via suitable intermediate components. It is also contemplated that the bumper stay can be employed with suitable vehicle components associated with unibody vehicle constructions and subframe components.

A first embodiment of bumper stay 10 as disclosed herein is illustrated in FIG. 1 in association with a schematically illustrated vehicle platform 12 and a bumper assembly 14 including a bumper beam 16 and a fascia or cladding 18 covering the beam.

Bumper stay 10 can have any suitable cross-sectional configuration. As depicted, bumper stay 10 has a hollow polygonal cross-sectional configuration. The bumper stay 10 may be formed in any manner such as from a pre-welded blank form. The bumper stay 10 includes a first length 22 and a second length 20. As depicted, each sublength is formed of a metallic material and the lengths are welded together at weld seam 24 to form the stay 10. Second length 20 is formed of a relatively thick material and first length 22 is formed of a relatively thin material. Material thickness for second length 20 will be that capable of resisting crumpling or compression in an impact event (i.e. “crushing”). In comparison, first length 22 will have less material thickness and therefore be prone to crushing in an impact event. Thickness of the first and second lengths 20, 22 can vary depending upon the desired level of compression resistance, deformability of the material, and configuration, and the like. Where a bumper stay is formed of alloy steel, a nonlimiting example of suitable material thickness for second length 20 is a thickness of 2.0 to 3.5 mm while first length 22 may be formed of material having a thickness of 1.6 to 2.6 mm. Nonlimiting examples of the ratio of the relative thicknesses of second length 20 to first length 22 is a ratio between 4:1 and 3:2. The orientation of first and second lengths relative to the respective bumper and chassis will be that capable of providing suitable crushablilty to the bumper stay in an impact event. As depicted, first length 22 is suitably secured to bumper beam 16 utilizing tabs or flanges 22a and second length 20 is suitably secured to platform 12 utilizing tabs or flanges 20a.

It will be understood that schematically illustrated platform 12 includes the frame and chassis components of the vehicle and varies depending on whether the vehicle employs a body on frame construction, uni-body construction, or sub-frame construction.

In an impact scenario or event, the relatively thin first length 22 provides a relatively crushable region and the relatively thick second length 20 provides a relatively noncrushable region. As best seen in FIG. 4, in the event of an impact, the first length 22 will undergo foreshortening and crushing while the second length 20 will essentially retain its integrity.

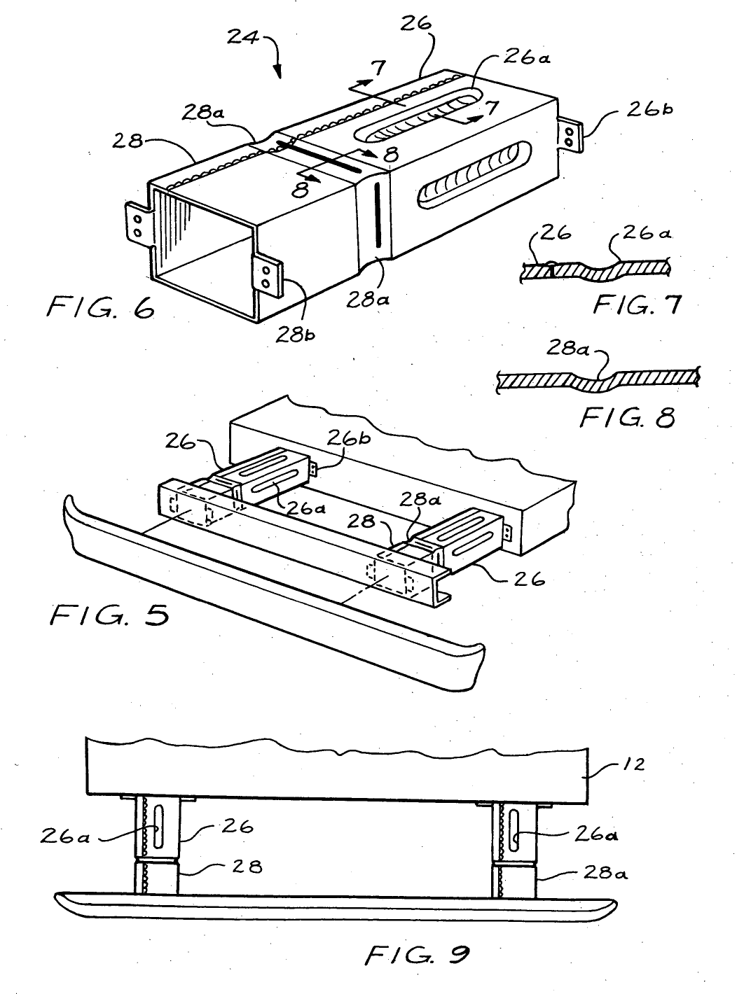

In the second embodiment as depicted in FIGS. 5-9, the bumper stay has a hollow polygonal cross-sectional configuration and includes a first length and a second length 26 with the first length 28 being crushable relative to the second length 26. The second length 26 includes at least one reinforcement 26a extending parallel to the length of the bumper stay. Reinforcement 26a may be a bead, groove or other structure positioned on the second length 26 so as to enhance or promote the crush resistance of the associated region. As depicted the reinforcement 26a is centrally positioned on at least one face of the second length 26. It is contemplated that the second length 26 can include multiple reinforcements 26a positioned on the second length in spaced relation to one another. As depicted, the second length 26 includes at least one reinforcement 26a on each face oriented essentially parallel to the length of the bumper stay 10.

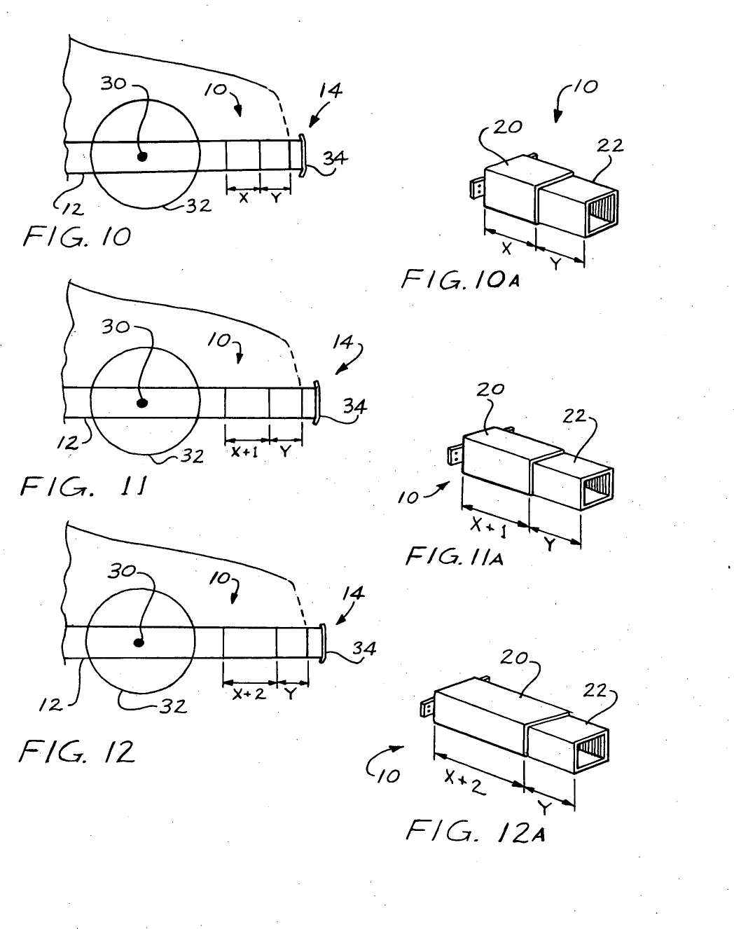

First length 28 includes at least one weakening structure 28a extending transversely of the length of the bumper stay 10. The weakening structure may be a bead or grove or other structure to promote or enhance the crushability of first lengthy 28. The weakening structure 28a can be positioned on the first length 28 at any location that can promote or enhance crushability. As depicted, the weakening structure 28a extends circumferentially around the first length 28 proximate to the junction between second length 26 and first length 28. It is contemplated that weakening structure 28a may be discontinuous if desired or required. Second length 26 is secured to the platform 12 utilizing tabs or flanges 26b and the first length 28 is secured to the bumper beam 16 utilizing tabs or flanges 28b. In an impact scenario, as best seen in FIG. 9, relatively crushable first length 28 undergoes foreshortening or crushing while relatively noncrushable second length 26 essentially retains its integrity.

A method of providing a vehicle bumper stay of specified crushability useable with more than one member of a family of vehicles utilizing a common platform, but having a varying overhang depending upon the size of the vehicle is disclosed herein and is depicted in FIGS. 10, 11, and 12. Overhang in this context is understood to be the distance from the center 30 of the front wheels 32 to the front end 34 of the vehicle as defined by the bumper assembly 14. For example, a compact size vehicle having a relatively short overhang is illustrated schematically in FIG. 10; a mid size vehicle having a moderate amount of overhang is illustrated schematically in FIG. 11; and a full size vehicle having a large overhang is illustrated schematically in FIG. 12.

Utilizing the bumper stay 10 as disclosed herein, in combination with the compact vehicle of FIG. 10 may comprise a first length 22 and a second length 20 in which the first length is crushable relative to the second length 20. The first length 22 has a length “Y” and the second length 20 has a length “X”. Lengthy “Y” of first length 22 is selected to provide desired crushability, and is substantially constant for two or more of the family of vehicles having different overhangs. In this sense, it is said that length “Y” is “fixed” or “predetermined.”

For example, in the mid size vehicles of FIG. 11, the second length 20 may have a length of “X+1” and the first length 22 may retain the length of “Y.”

In the full size vehicle of FIG. 12, the second length 20 may have a length of “X +2” and the first length 22 may continue to retain the length of “Y.”

The methodology as disclosed herein will be seen to provide a specified crushability of the bumper stay irrespective of overhang and avoids the problems with the long stays of the prior art necessitated by long overhangs wherein the crushability is unpredictable and often results in buckling or breakage of the stay rather than a controlled crushability.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A bumper stay adapted to extend between a vehicle component and a vehicle bumper, the bumper stay comprising:
a first length that is relatively crushable; and
a second length that is relatively non-crushable.

2. The bumper stay of claim 1, wherein the first length is proximate the vehicle bumper and the second length is proximate the vehicle component.

3. The bumper stay of claim 1, wherein:
the bumper stay has a hollow polygonal cross-sectional configuration; and
the first length has a relatively thin material thickness and the second length has a material thickness greater than the material thickness of the first length.

4. The bumper stay of claim 3, wherein the thickness of the second length and the thickness of the first length have a ratio between 4:1 and 3:2.

5. The bumper stay of claim 1, wherein:
the bumper stay has a hollow polygonal cross-sectional configuration; and
wherein the first length includes at least one weakening structure extending transversely of the length of the bumper stay.

6. The bumper stay of claim 5, wherein:
the weakening structure is positioned at a location proximate to a junction between the first length and the second length.

7. The bumper stay of claim 5, wherein:
the weakening structure extends circumferentially around the bumper stay.

8. The bumper stay of claim 1, wherein:
the bumper stay has a hollow polygonal cross section; and
the second length includes at least one reinforcement extending parallel to the length of the bumper stay.

9. The bumper stay of claim 8, wherein:
the second length comprises at least two reinforcements extending parallel to the length of the bumper stay.

10. The bumper stay of claim 8, wherein:
the first length includes at least one weakening structure extending transversely of the length of the bumper stay.

11. For use with a plurality of vehicles each having a bumper and a common platform but having overhangs of varying distance, a method of installing a vehicle bumper stay in one of the plurality of vehicles, the method comprising:
providing a bumper stay adapted to extend between a vehicle component and a vehicle bumper, the bumper stay having a first length that is relatively crushable and is of a predetermined size, and a second length that is relatively non-crushable and is of a size selected to permit the bumper stay to span the distance between the vehicle component and the bumper; and
securing the bumper stay to the vehicle component and the bumper.

12. The method of claim 11, wherein:
the first length is provided with a hollow polygonal cross-sectional configuration of a specified thickness; and the second length is provided with a thickness greater than the thickness of the first length.

13. The method of claim 11, wherein:
the first length is provided with least one weakening structure extending transversely to the length of the bumper stay, the weakening structure contributing to the crushability of the first length relative to the second length.

14. The method of claim 13, wherein:
the second length is provided with at least one reinforcement extending parallel to the length of the bumper stay.

15. The method of claim 11, wherein:
the second length is provided with at least one reinforcement extending parallel to the length of the bumper stay.

16. A vehicle comprising:
a vehicle component;
a bumper beam spaced apart from the vehicle component; and
a bumper stay including a first length proximate to the bumper beam and a second length proximate to the vehicle component, wherein the first length is relatively crushable and the second length is relatively non-crushable.

17. The vehicle of claim 16, wherein the bumper stay is an elongated hollow shaft and the first length has a first thickness and the second length has a second thickness that is greater than the first thickness.

18. The vehicle of claim 16, wherein the second length has at least one reinforcement extending at least a portion of the second length and oriented parallel to the bumper stay.

19. The vehicle of claim 18, wherein the first length has at least one weakening structure defined thereon, the weakening structure extending transversely to the bumper stay.

20. The vehicle of claim 16, wherein the first length has a fixed length and a second length has a length sized to permit the bumper stay to span the distance between the vehicle component and the bumper.
